(19) United States
(12) Patent Application Publication
(10) Pub. No.: US 2007/0022846 A1
(43) Pub. Date: Feb. 1, 2007

(54) Power wrench

(76) Inventor: Matthew Fryatt, Toronto (CA)

Correspondence Address: DENNISON ASSOCIATES, 133 RICHMOND STREET WEST, SUITE 301, TORONTO, ON, M5H 2L7, CA

(21) Appl. No.: 11/193,502

(22) Filed: Aug. 1, 2005

(51) Int. Cl. B25B 17/00; B25B 21/00; B25B 13/00

(52) U.S. Cl. 81/57.3; 81/57.14; 81/57.43

(57) ABSTRACT

A power wrench comprises a length of rigid bar to be held in one hand, thesw bar having a socket member for fitting a nut or head of a bolt rotatably mounted therein at one end, an adaptor adapted to be driven by a power driver rotatably mounted therein at an opposite end, and a drive means for driving said socket member from said adaptor.

### FIELD OF THE INVENTION

This invention relates to a power driven wrench for tightening and loosening nuts, bolts and the like in tight or awkward locations which are inaccessible to a power driver.

### BACKGROUND OF THE INVENTION

While there are various types of power operated wrenches in the prior art for fastening and loosening nuts and bolts and the like, most are simply not useful where working in tight or not readily accessible spots.

For example, U.S. Pat. No. 5,010,792 discloses a ratchet wrench which is driven by a power drill engaging a concentric stub shaft provided on the ratchet gear. The use of the power drill is only possible where there is room to apply it. While the ratchet gear can be operated manually through a handle, it does so without any applied power.

To overcome the limitations of the use of power operated wrenches such as disclosed in U.S. Pat. No. 5,010,792, a number of power operated wrenches have been proposed where the wrench itself incorporates a source of power.

Thus, U.S. Pat. No. 4,993,288 discloses a ratchet wrench with a handle to enable the wrench to operate in tight spots. The handle itself incorporates an air motor 11 which drives a rotatable crank shaft to effect the ratcheting of the wrench. Such a wrench is costly involving the assembly of a large number of delicate parts rendering it unreliable.

In the same vein, U.S. Pat. No. 6,739,221 B2 discloses a power wrench that has a handle which incorporates a battery operated electric motor to drive a rotatable nut or bolt head receiving socket. The multiplicity of parts and components, including the need to replace the battery, make this wrench both costly and bulky with limited accessibility to very tight or awkward spots.

The medical and dental arts include remote controlled hand operated delicate rotating instruments which show the use of one hand to apply the tool and the other hand to operate a remote control knob. Such delicate instruments obviously are incapable of being power operated.

Thus, U.S. Pat. No. 5,458,603 shows a surgical instrument at one end of the handle and a hand operated thumb wheel operating control adjacent the other end. The rotation of the instrument is effected incrementally under the careful hand of the surgeon through any number of possible drives including belts, chains and gears.

In a similar vein, U.S. Pat. No. 5,236,359 shows a dental instrument in which a rigid arm has a rotatable instrument at one end which the dentist holds against the bone with one hand while he remotely rotates the tool with the other hand by a knob connected to the tool through a chain drive.

Such delicate surgical instruments, of course, could not be driven by any form of power tool.

### SUMMARY OF THE INVENTION

The present invention is directed to a very simple, low cost, power driven wrench for applying or tightening and for loosening or removing nuts or bolts in situations inaccessible to direct use of a power driver or tool.

More particularly, the invention resides in providing a power wrench having a nut or bolt head socket rotatably mounted at one end and an adaptor adapted to interfit with a hand held power driver rotatably mounted at the other end with a drive connection between the rotatable socket and the rotatable adaptor for tightening or loosening a nut or bolt.

In a preferred embodiment of the invention, the power wrench comprises a hollow rigid bar having a socket member for fitting a nut or head of a bolt rotatably mounted at one end, an adaptor adapted to be driven by a power driver rotatably mounted at the other end, and a drive means for driving the socket member from the adaptor.

These and other features of the invention will become apparent from the following detailed description with reference to the drawings.

### BRIEF DESCRIPTION OF THE DRAWINGS

FIG. 1 is a perspective view of an embodiment of the power wrench showing it about to tighten a bolt through the use of a hand held power driver;

FIG. 2 is an exploded perspective view of the power wrench of FIG. 1;

FIG. 3 is an underside plan view of the power wrench with the bottom bar removed;

FIG. 4 is an enlarged transverse cross section of the power wrench of FIG. 1.

### DETAILED DESCRIPTION ACCORDING TO THE PREFERRED EMBODIMENTS OF THE PRESENT INVENTION

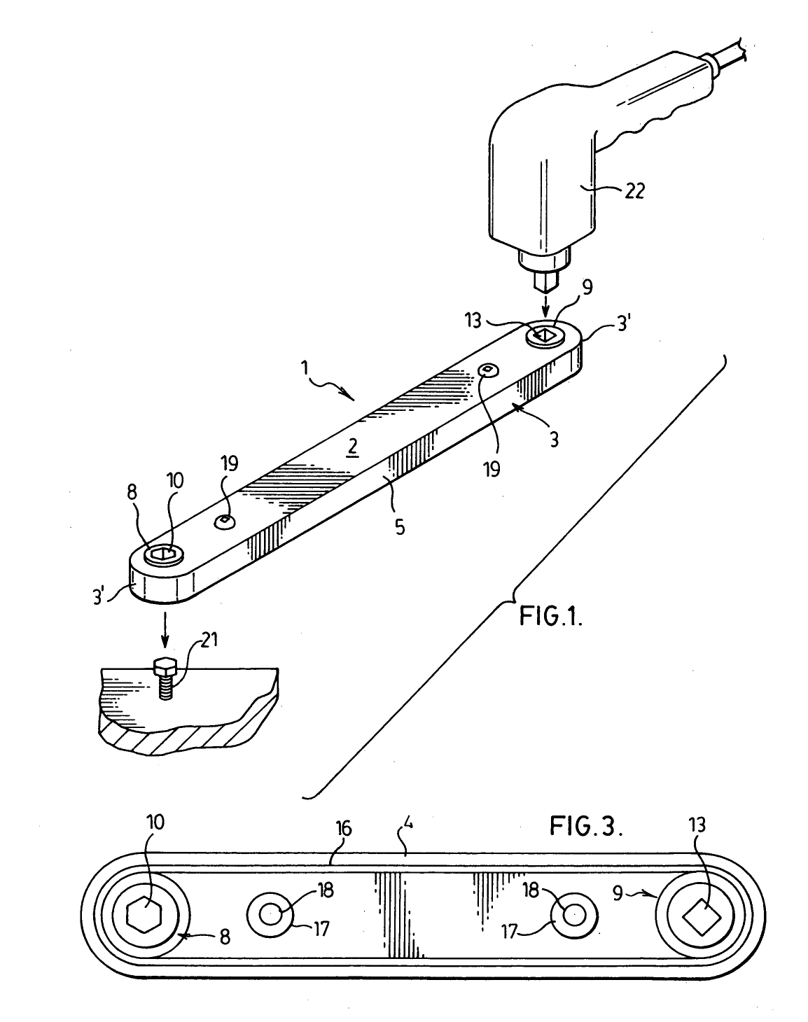

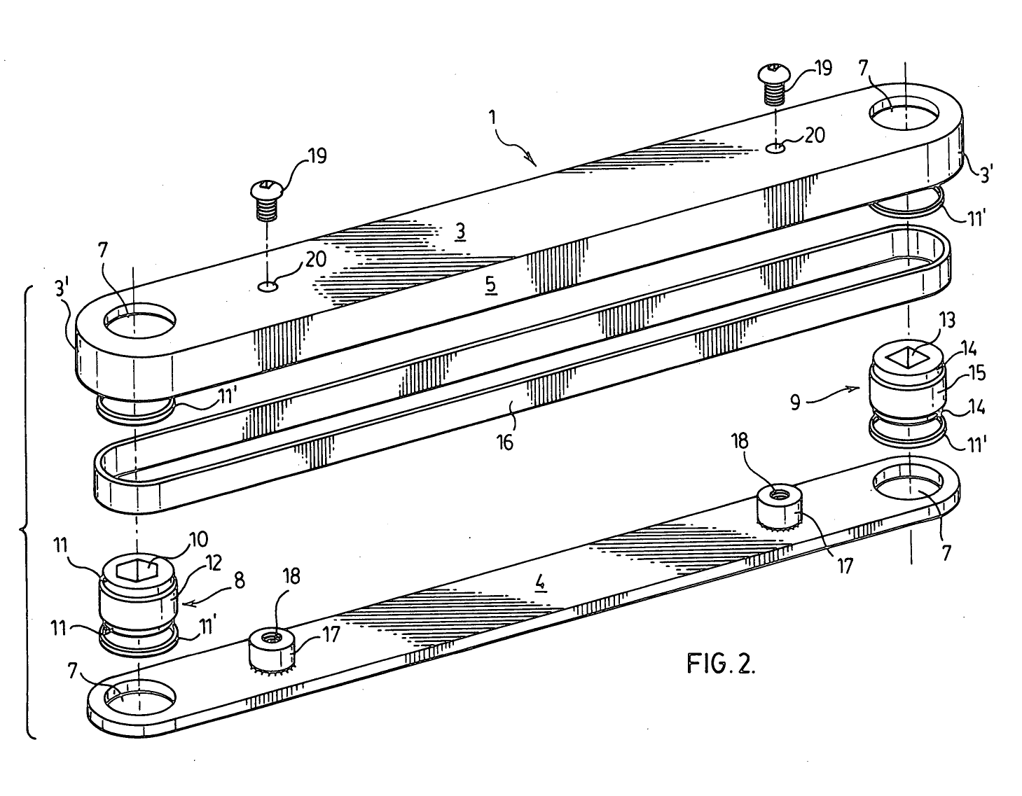

With reference to FIGS. 1 and 2, the power wrench generally designated as 1 comprises a hollow rigid bar 2 with rounded ends. Bar 2 is preferably made of metal but it could also be made of a suitable plastic.

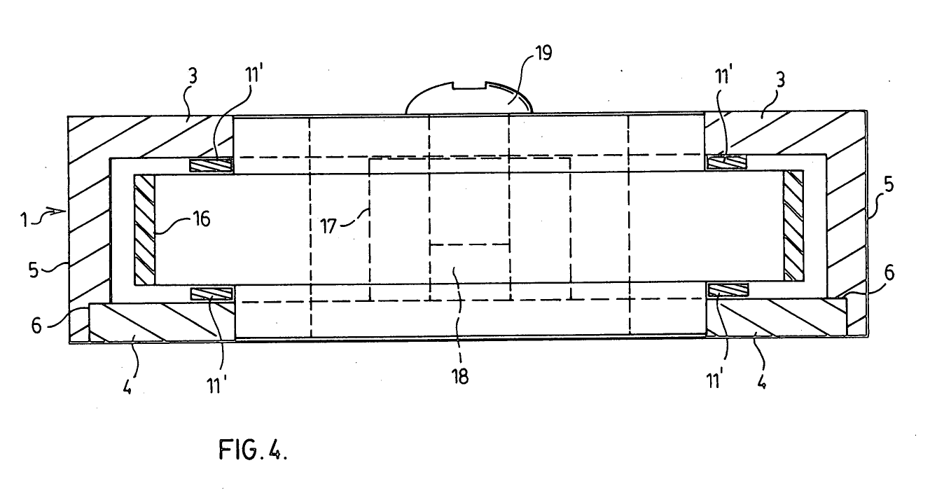

As shown in FIG. 2 and particularly in FIG. 4, the hollow bar 2 is made up of a channel shaped member 3 having rounded closed ends 3′ and a mating planar base 4.

The side walls 5 of channel 3 are notched as at 6 at their lower edges to receive the base 4.

The ends of the channel member 3 and base 4 are provided with registering circular openings 7. The driven socket member 8 is rotatably mounted in the openings 7 at one end of the bar 2 while the power tool adaptor 9 is rotatably mounted in the openings 7 at the other or opposite end of the bar 2.

The socket member 8 is cylindrical with a shaped bore 10 to fit a nut or bolt head. Socket member 8 has reduced cylindrical end portions 11 adapted to be received in the openings 7 at the one end of the wrench while the cylindrical main portion 12 of the socket member 8 between the ends 11 provides a belt engaging drive surface. Washers 11′ sleeved on the end portions 11 of the socket member are interposed between the main portion 12 of the socket member and the underside of the channel 3 and the upper side of the planar base 4.

The adaptor 9 is also cylindrical with a shaped bore 13 shaped to receive and fit the end of a power driver. Adaptor 9 has reduced cylindrical ends 14 extending from a main cylindrical body 15 which provides a belt drive surface. The reduced cylindrical ends 14 of the adapter are rotatably mounted in the circular openings 7 at the end of the bar remote from the socket member 8.

Again, washers 11′ sleeved on the cylindrical ends 14 of the adaptor are interposed between the underside of the channel member 3 and the upper side of the planar base 4.

Drive between the adaptor 9 and the socket member 8 is effected by a tensioned endless belt 16 engaging the cylindrical central portion 15 of the adaptor and the cylindrical central portion 12 of the socket member 8.

The planar base 4 is provided with a pair of studs 17 with threaded bores 18 adapted to receive threaded fasteners or screw 19 introduced through suitable holes 20 in the channel 3. Thus, after the endless belt 16 has been assembled on the adaptor and socket, the channel 3 is secured to the planar base 4 by the screws 19 and the wrench is ready for operation.

Because the drive belt is totally enclosed, the wrench can be safely handled without danger to the fingers.

In operation the user holding the bar with one hand can apply the socket end of the wrench to, for example, the head of a bolt 21 while contacting the adaptor at the other end with a power driver 22 as illustrated in FIG. 1.

While the belt tension is such as to ensure that a nut or bolt is firmly tightened or loosened, if the power driver does not have its own clutch when, say the nut or bolt is fully tightened, the belt itself will form a clutch providing for slippage so that the reaction back on the user's hand holding the power driver will not cause the driver to jump out of the adaptor. However, it will be understood that other suitable drive means between the socket member 8 and the adaptor 9 can be used.

While the preferred embodiment of the wrench bar has been shown and described, it will be understood that various modifications may be made in the construction of the wrench without departing from the scope of the appended claims.

1. A power wrench comprising a length of rigid bar to be held in one hand, said bar comprising a hollow channel having a bottom wall, parallel side walls, joined by rounded end walls, and a top wall closing said channel, and having a socket member for fitting a nut or head of a bolt rotatably mounted within a rounded end wall at one end of said bar, an adaptor adapted to be driven by a power driver rotatably mounted within a rounded end wall at an opposite end of said bar, and an endless drive means for driving said socket member from said adaptor, said endless drive means being located within said channel juxtaposed to and guided by said parallel side walls and said rounded end walls.

2. (canceled)

3. (canceled)

4. (canceled)

5. A power wrench as claimed in claim 41 in which said socket member and said adaptor each have cylindrical end portions with the end portions of said socket member being journalled in respective registering circular openings in said channel bottom wall and said channel top wall at said one end of said bar and with the end portions of said adaptor being journalled in respective registering circular openings in said channel bottom wall and top wall at said opposite end of said bar, said socket member and said adaptor each having an enlarged cylindrical body portion between said cylindrical end portions, and said drive means comprises an endless belt stretched between said socket member and said adaptor and sleeved on said enlarged cylindrical body portions of said socket member and said adaptor member.

6. (canceled)
